(19) United States
(12) Patent Application Publication
(10) Pub. No.: US 2010/0302006 A1
(43) Pub. Date: Dec. 2, 2010

(54) Rapid Device Customization Using a Specialized Dual-Access RFID Tag

(76) Inventor: Pv Subramanian, Frederick, MD (US)

Correspondence Address: MOTOROLA, INC., 1303 EAST ALGONQUIN ROAD, IL01/3RD, SCHAUMBURG, IL, 60196, US

(21) Appl. No.: 12/473,538

(22) Filed: May 28, 2009

(51) Int. Cl. H04B 7/00

(52) U.S. Cl. 340/10.1

(57) ABSTRACT

A system and techniques for configuring a computer device are disclosed. The system and techniques employ a specialized RFID tag and process that rapidly personalize a computing device and eliminate the need to unpack and power up the device as a prerequisite to configuration.

### TECHNICAL FIELD

This disclosure relates to device personalization using a specialized dual-access RFID tag.

### BACKGROUND

Computer devices such as laptops, mobile computers, PDAs, and routers, typically require enterprise- or end-user personalization. The data associated with the personalization may be extensive and is typically associated with a unique personality key. Example personality keys can include a login ID for a corporate laptop, an application profile for an enterprise PDA, a region code in a wireless router, and the like.

Configuring a computer device to a specific personality is typically done as part of a custom rework process and involves powering up the device and setting appropriate configuration information, which can minimally include the personality key. The configuration process typically involves unpacking the computer device, performing a personalization and quality control process, and then repackaging the device. As it exists today, this configuration process can be slow, affect manufacturing throughput, and introduce errors. Furthermore, shipping completely personalized devices may create a security risk.

Accordingly, there is a need for an improved system and techniques for configuring and personalizing computer devices.

### SUMMARY

A system and techniques for configuring a computer device are disclosed. The system and techniques employ a specialized Radio-Frequency IDentification (RFID) tag and process that rapidly personalizes a computing device and eliminate the need to unpack and power up the device as a prerequisite to configuration.

Various aspects of the invention relate to encoding and querying information on an RFID tag associated with a computer device. For example, according to one aspect, a method of configuring a computer device using RFID technology includes encoding first device configuration information on an RFID tag associated with a computer device using a wireless communication capability of the tag. The first device configuration information includes system level operational information or a reference to the system level operational information for the computer device. The method also includes querying the RFID tag from the computer device for the first device configuration information using a wired communication port of the tag, and configuring the computer device using the first device configuration information.

In one embodiment, the method further includes prompting for second device configuration information upon powering up the computer device in response to the first device configuration, and configuring the computer device using the second device configuration information, the second device configuration information being user-specific operational information for the computer device.

The method can include encoding the first device configuration information subsequent to packaging the computer device. In another embodiment, the computer device is packaged after encoding the first device configuration information. The RFID tag can also be pre-installed in the computer device.

In one embodiment, the method can include comparing authentication information derived from the second device configuration information, and authorizing use of the computer device based on the comparison.

In another aspect, a RFID configurable computer device is disclosed that includes a RFID tag associated with the computer device. The tag is configured to include 1) a wireless communication capability for receiving encoded first device configuration information and 2) a wired communication port for transmitting the first device configuration information. The first device configuration information includes either system level operational information or a reference to system level operation information for the computer device. The device also includes a configuration module configured in a memory of the computer device. The configuration module includes memory storing instructions that, in response to receiving a request for access to a service, cause a processor of the device to query the RFID tag for the first device configuration information using the wired communication port of the tag, and configure the computer device using the first device configuration information.

In yet another aspect, an RFID tag is disclosed that includes a wireless communication means for receiving encoded first device configuration information, and a wired communication means for transmitting the first device configuration information, the first device configuration information including system level operational information for a computer device.

Several benefits can be derived from the present invention. For example, the present invention can be used to reduce the number of unique SKUs that a manufacturer needs to maintain. In addition, standard “off-the-shelf” computer devices can be personalized quickly and efficiently customized just prior to shipment. Furthermore, multiple computer device units can be personalized simultaneously.

Additional features and advantages will be readily apparent from the following detailed description, the accompanying drawings and claims.

### BRIEF DESCRIPTION OF DRAWINGS

FIG. 1 is a schematic representation of a packaged computer device and a dual-access RFID tag encoded with first device configuration according to an embodiment of the present invention.

FIG. 2 is a schematic representation of an unpackaged computer device adapted to receive information from the dual-access RFID encoded tag of FIG. 1

FIG. 3 illustrates an exemplary method of configuring a computer device using the dual-access RFID tag shown in FIGS. 1 and 2 according to an embodiment of the present invention.

Like reference symbols in the various drawings indicate like elements.

### DETAILED DESCRIPTION

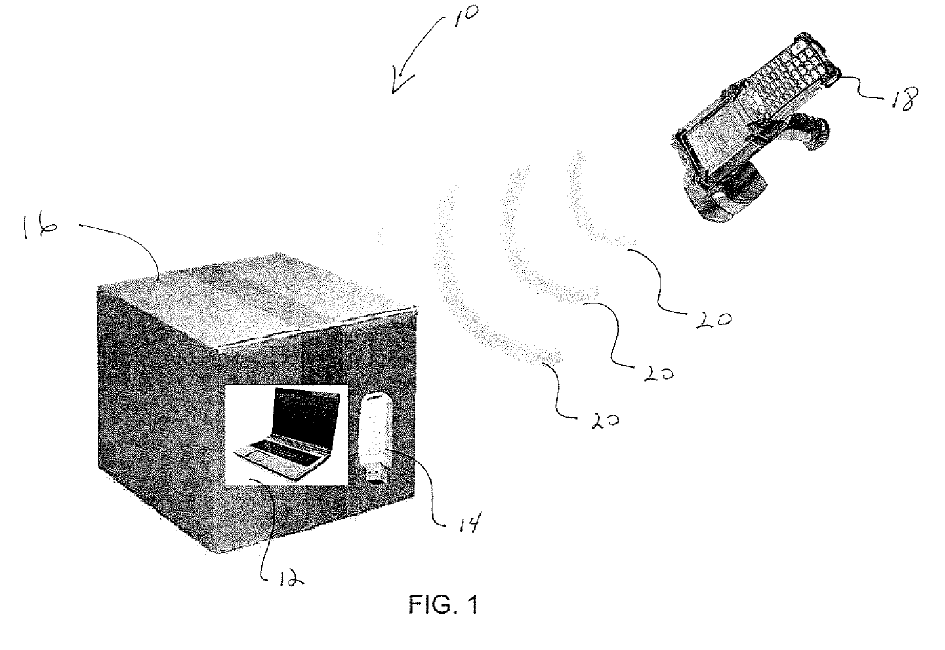

Referring now to FIG. 1, a system 10 for rapid device customization of a computer device 12 using a specialized dual-access RFID tag 14 is disclosed. Example computer devices can include, but are not limited to, a mobile computer, a desktop computer, a cellular phone, a Personal Digital Assistant (PDA), and communication network equipment, such as routers, access points, switches, and the like.

As shown in FIG. 1, in one embodiment, the computer device 12 and associated dual-access tag 14 can be co-located in a device package 16. It will be appreciated by one skilled in the art, however, that the present invention is not limited to either the device 12 or tag 14 being included in the package 16.

The dual-access RFID tag 14 of the present invention is capable of being interrogated and encoded over the air by a compatible RFID reader 18 as well as being queried over a tag provided wired link, such as over a serial or USB port. In one embodiment, the RFID tag 14 is encoded subsequent to packaging the device 12 and tag 14. In another embodiment, tag data is encoded prior to the computer device 12 and tag 14 being packaged and ready to ship.

In one embodiment, the dual-access tag 14 is configured to include both a wireless communication capability for receiving encoded first device configuration information 20 and a wired communication port for transmitting the first device configuration information. The first device configuration information 20 includes system level operational information for the computer device to operate. An example of the first device configuration information 20 includes, but is not limited to, system commands and configuration files for the computer device 12.

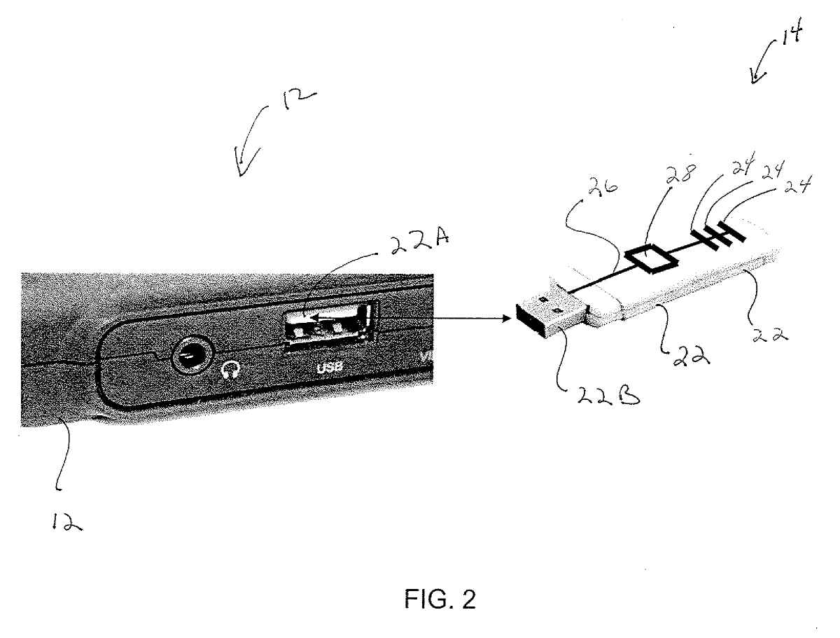

Turning now to FIG. 2, additional details of the dual-access RFID tag 14 of the present invention are disclosed. As shown in FIG. 2, the RFID tag 14 includes a substrate 22, an antenna 24 for receiving and encoding data on the tag 14, a wired communication port 26 for allowing encoded tag data to be queried, such as a serial or USB port, and an integrated circuit (IC) 28 for controlling operation of the tag 14.

In one embodiment, the antenna 24 is formed on a surface of the substrate 22. Antenna 24 may include any number of one, two, or more separate antennas of any suitable antenna type, including dipole, loop, slot, or patch antenna type. IC 28 includes one or more integrated circuit chips/dies, and can include other electronic circuitry. IC 28 is attached to substrate 22, and is coupled to the antenna 24 and wired communication port 26. IC 28 may be attached to substrate 22 in a recessed and/or non-recessed location.

The IC 28 controls operation of tag 14, receives signals from the RFID reader 18 using the antenna 24, and allows encoded RFID tag data stored in a memory of the IC 28 to be queried via the wired communication port 26. In one embodiment, the IC 28 also includes control logic, a charge pump, a demodulator, and a modulator. As known to one skilled in the art, an input of charge pump, an input of demodulator, and an output of modulator are coupled to the antenna 24 via an antenna signal.

It will be recognized by persons skilled in the relevant art(s) that tag 14 also may include any number of modulators, demodulators, charge pumps, and antennas. Tag 14 may additionally include further elements, including an impedance matching network and/or other circuitry that can be pre-installed in the computer device prior to packaging. Furthermore, although the tag 14 shown in FIGS. 1 and 2 is a passive tag, the dual-access RFID tag 14 may alternatively be an active tag (e.g., powered by battery) or a passive/active tag.

Advantageously, the system 10 can utilize the dual-access RFID tag 14 to rapidly personalize one or more off-the-shelf computer devices as well as eliminate the need to unpack and power up the computer device as a prerequisite to configuration.

For example, in one embodiment, as shown in FIG. 1 when the computer device 12 and tag 14 are packaged, a personalization key can be encoded by the reader 18 into the RFID tag 14 using the wireless capability of the tag 14. Advantageously, there is no need to open the device packaging 16 or setting up the computer device 12 on an assembly line to customize the device 12, as the personalization key is transmitted through the packaging, and the passive tag 14 does not require any power from the device 12. Furthermore, multiple computing devices associated with dual-access RFID tags of the present invention can be personalized almost simultaneously.

When the computer device 12 reaches its destination and is powered up for the first time, the RFID tag 14 is attached to the computer device 14 over the wired communication port. For example, as shown in FIG. 2, in one embodiment, a type A male USB port 22B of the tag 14 is attached to a type A female USB port 22A of the computer device 12.

Upon connection of the tag 14 to the device 12 over the wired communication port, a pre-installed configuration module in the memory of the device 12 queries the dual-access RFID tag 14 over the port 26 and configures the device 12 using the personalization key included in the first device configuration information. In another embodiment, the computer device 12 is connected to a network and the configuration module downloads and/or uploads one or more files, as identified in the first device configuration information. For example, in one embodiment, the configuration module of the device 12 downloads data files from a social network website for use on the device 12.

The configuration module included in the memory of the computer device 12 can request that the user authenticate himself or herself, with the authentication information compared to data stored on the dual-access RFID tag 14. For example, in one embodiment where the dual-access RFID tag 14 is pre-installed in the computer device 12, the configuration module prompts the user for second device configuration information upon powering up the computer device 12, and configures the computer device 12 using the second device configuration information.

In another embodiment, upon attaching the tag 14 to the computer device 12, the configuration module prompts the user for second device configuration information and then configures the computer device 12 using the entered second device configuration information. The second device configuration information is user-configurable information for operation of the device 12. For example, user-configurable information includes, but is not limited to, background display colors, audio settings, security (e.g., password settings, file locks, etc.), and the like.

In one embodiment, the configuration module compares authentication information derived from the second device configuration information, and authorizes use of the computer device based on the comparison.

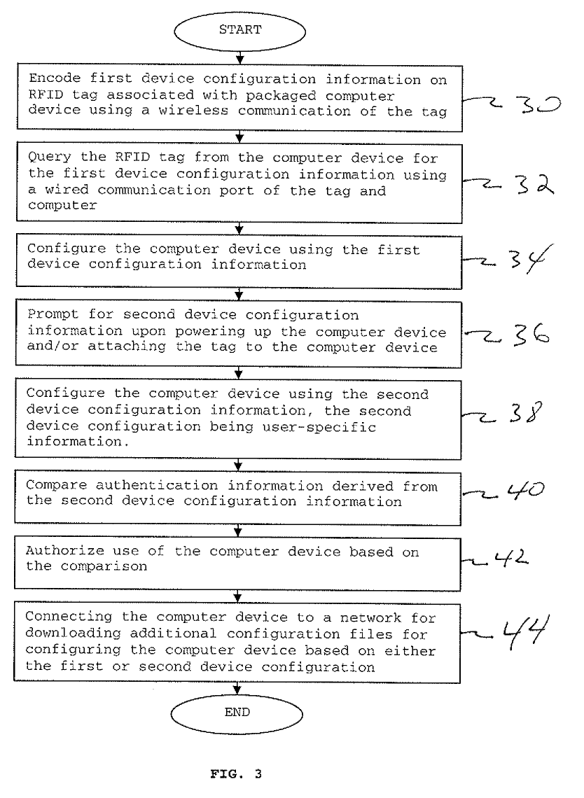

Referring now to FIG. 3, an exemplary method of configuring a computer device using RFID technology is disclosed. As shown in FIG. 3, first, at step 30, the method includes encoding first device configuration information on an RFID tag 14 associated with a computer device 12 using a wireless communication capability of the tag 14. As discussed previously, the first device configuration information can include system level operational information and/or a reference to system level operational information for the computer device. Next, at step 32, upon powering on the computer device 12 and attaching the tag 14 to the device 12, the configuration module of the device 12 queries the RFID tag over a wired communication port for first device configuration information. Next, at step 34, the configuration module configures the computer device 12 using the first device configuration information.

In one embodiment, at step 36, the method also includes the configuration module prompting the user for second device configuration information upon attaching the tag 14 to the computer device 12. At step 38, the method includes the configuration module configuring the computer device using the second device configuration information. As mentioned previously, the second device configuration information can be user-specific information for operation of the computer device 12.

At step 40, the configuration module compares authentication information derived from the second device configuration information and authorizes use of the computer device 12 based on the comparison 42.

The method can also include connecting the computer device 12 to a network for downloading additional configuration files for configuring the computer device 12 based on either the first or second device configuration information 44. For example, in one embodiment, as explained previously, the additional configuration files downloaded can relate to a social networking website.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

What is claimed is:

1. A method of configuring a computer device using RFID technology comprising:
encoding first device configuration information on an RFID tag associated with a computer device using a wireless communication capability of the tag, the first device configuration information including at least one of system level operational information and a reference to system level operational information for the computer device;
querying the RFID tag from the computer device for the first device configuration information using a wired communication port of the tag; and
configuring the computer device using the first device configuration information.

2. The method of claim 1, further comprising:
prompting for second device configuration information upon powering up the computer device in response to the first device configuration; and
configuring the computer device using the second device configuration information, the second device configuration information being user-specific operational information for the computer device.

3. The method of claim 2, comprising encoding the first device configuration information without unpacking the computer device from the computer device package.

4. The method of claim 2, wherein the computer device is packaged during encoding the first device configuration information.

5. The method of claim 2, wherein the RFID tag is pre-installed in the computer device.

6. The method of claim 5, wherein the wired communication port is at least one of a USB port and a serial port.

7. The method of claim 2, wherein configuring the computer device comprises setting user-defined parameters for operation of the computer device.

8. The method of claim 2, further comprising:
comparing authentication information derived from the second device configuration information; and
authorizing use of the computer device based on the comparison.

9. The method of claim 1, further comprising transmitting the first device configuration to the tag using an RFID reader.

10. The method of claim 1, wherein the computer device is selected from the group consisting of a mobile computer, desktop computer, cellular phone, and communication network equipment.

11. The method of claim 1, comprising connecting the computer device to a network for downloading additional configuration files for configuring the computer device.

12. The method of claim 11, wherein the additional configuration files relate to a social networking website.

13. An RFID configurable computer device comprising:
a RFID tag associated with the computer device, the tag configured to include 1) a wireless communication capability for receiving encoded first device configuration information and 2) a wired communication port for transmitting the first device configuration information, the first device configuration information including system level operational information for the computer device;
a configuration module configured in a memory of the computer device, the configuration module including memory storing instructions that, in response to receiving a request for access to a service, cause a processor of the device to:
query the RFID tag for the first device configuration information using the wired communication port of the tag;
configure the computer device using the first device configuration information.

14. The computer device of claim 13, wherein the memory stores instructions that, in response to receiving the request, cause the processor to:
prompt for second device configuration information upon powering up the computer device in response to the first device configuration; and
configure the computer device using the second device configuration information, the second device configuration information being user-configurable operational information for the device.

15. The computer device of claim 14, wherein the first device configuration information is encoded on the tag without unpacking the computer device from a computer device package.

16. The computer device of claim 14, wherein the RFID tag is pre-installed in the computer device.

17. The computer device of claim 14, wherein the wired communication port is at least one of a USB port and a serial port.

18. The computer device of claim 13, wherein the memory stores instructions that, in response to receiving the request, cause the processor to:
compare authentication information derived from the second device configuration information; and
authorize use of the computer device based on the comparison.

19. The computer device of claim 13, wherein the device is a mobile computer, desktop computer, cellular phone, or communication network equipment.

20. The computer device of claim 13, wherein the device is in communication with a social network website.

21. An RFID tag comprising:
a wireless communication means for receiving encoded first device configuration information; and
a wired communication means for transmitting the first device configuration information, the first device configuration information including system level operational information for a computer device.
